(19) United States
(12) Patent Application Publication
(10) Pub. No.: US 2010/0015833 A1
(43) Pub. Date: Jan. 21, 2010

(54) HIGH DENSITY SPRING CONTACT CONNECTOR

(75) Inventors: Patrick John Laughlin, Thousand Oaks, CA (US); Michael Craig MacBrair, JR., Napa, CA (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 12/173,890

(22) Filed: Jul. 16, 2008

(51) Int. Cl. H01R 13/652

(52) U.S. Cl. 439/271

(57) ABSTRACT

A densely populated micro miniature connector includes a plug and a receptacle configured to securely mate with each other. Connector plugs include an insert assembly having at least one double-ended pin, a housing, and a coupling ring. Connector receptacles include an insert assembly having at least one spring probe and a housing. The double-ended pin contacts the spring probe when the plug and the receptacle are connected.

### TECHNICAL FIELD

The present application relates generally to cylindrical connectors having high performance capabilities for both general purposes and harsh environments. Generally, the connectors are used for low voltage data transmission.

### BACKGROUND OF THE INVENTION

Cylindrical connectors are typically used to join lengths of wires and to produce precision alignment of the wires for low voltage data transmission. Cylindrical connectors may be used, for example, in military applications, shipboard, aerospace applications, harsh environments, telecommunications, and armored applications. Conventional cylindrical connectors, such as MIL-DTL-38999 cables, include a plug and a receptacle, each having an insert assembly into which contacts are installed. Each individual contact is connected to a wire so precise alignment of the wires is possible when a plug contact is aligned with a receptacle contact. The insert assemblies require a contact retainer (or retaining ring) and a contact shoulder for each individual contact to lock each contact in place. However, only a limited number of contacts may be included in a connector of a given size due to the added size of including a retainer and shoulder for each contact; therefore, only a limited number of wires may be joined in a given cylindrical connector. For example, an insert assembly with shell size 13 has a diameter of about 0.522 inches and includes 22 contacts, while an insert assembly with shell size 17 has a diameter of about 0.772 inches and includes 55 contacts. Furthermore, insertion forces resulting from insertion and removal of contacts into conventional insert assemblies having retainers drag on the contacts and eventually lead to wear on the contacts.

Therefore, a need exists for an improved connector that includes more contacts in a given area to join more wires than conventional cylindrical connectors of the same size.

### SUMMARY OF THE INVENTION

The present invention relates to cylindrical connectors having an increased number of contacts in a given area over conventional cylindrical connectors. Thus, a greater number of wires may be joined using smaller connectors. The cylindrical connectors of the present invention include a plug and a receptacle. The receptacle includes an insert assembly having at least one spring probe. The plug includes an insert assembly having a doubled-ended pin configured to contact the spring probe upon mating of the plug and receptacle. The plug insert assembly includes an interface seal, a front insert, a rear insert, and a seal, each having an opening through which at least one doubled-ended pin, conductive tube, and/or contact pin is inserted. The geometry of each opening is such that the double-ended pin is held in place without the use of a retainer. The doubled-ended pin may have a generally pointed tip and extends slightly beyond the end of the plug insert assembly. The plug insert assembly is positioned within a housing that is positioned within a coupling ring. The receptacle insert assembly includes a front insert, a rear insert, and a seal, each having an opening through which at least one spring probe, conductive tube, and/or contact pin is inserted. The geometry of each opening is such that the spring probe is held in place without the use of a retainer. The spring probe is enclosed within the receptacle insert assembly. The spring probe has a beveled tip configured to receive the generally pointed tip of the plug double-ended pin when mated with the plug insert assembly. The receptacle insert assembly is positioned within a housing configured to engage and lock with the connector plug.

The geometry of the insert assemblies of the connectors allows for the inclusion of increased contacts in a given area over conventional connectors due to the elimination of the retainer required for conventional contacts. Furthermore, insertion forces that lead to wear of conventional contacts are minimized since the need for a contact retainer is eliminated.

These and other aspects, objects, features and embodiments of the present invention will become apparent to those skilled in the art upon consideration of the following detailed description of illustrated embodiments exemplifying the best mode for carrying out the invention as presently perceived.

### BRIEF DESCRIPTION OF THE DRAWINGS

The present invention may be better understood by reading the following description of non-limitative embodiments with reference to the attached drawings wherein like parts of each of the several figures are identified by the same reference characters, and which are briefly described as follows.

FIG. 1A is a perspective view of a plug according to an exemplary embodiment.

FIG. 1B is an exploded sectional view of the insert assembly of the plug of FIG. 1A according to an exemplary embodiment.

FIG. 1C is a sectional view of the housing and insert assembly of the plug of FIG. 1A according to an exemplary embodiment.

FIG. 1D is an exploded sectional view of the plug of FIG. 1A according to an exemplary embodiment.

FIG. 2A is a perspective view of a receptacle according to an exemplary embodiment.

FIG. 2B is an exploded sectional view of the insert assembly of the receptacle of FIG. 2A according to an exemplary embodiment.

FIG. 2C is an exploded sectional view of the receptacle of FIG. 2A according to an exemplary embodiment.

FIG. 3A is a sectional view of a connector showing the plug of FIG. 1A and receptacle of FIG. 2A disconnected according to an exemplary embodiment.

FIG. 3B is a sectional view of the connector of FIG. 3A showing the plug of FIG. 1A and receptacle of FIG. 2A partially connected according to an exemplary embodiment.

FIG. 3C is a sectional view of the connector of FIG. 3A showing the plug of FIG. 1A and receptacle of FIG. 2A fully connected according to an exemplary embodiment.

### DETAILED DESCRIPTION OF THE INVENTION

The invention provides connectors for joining two lengths of wires. The connectors have high performance capabilities for both general purposes and harsh environments. Generally, connectors of the present invention include a plug and a receptacle, each having an insert assembly with increased contact density over conventional connectors.

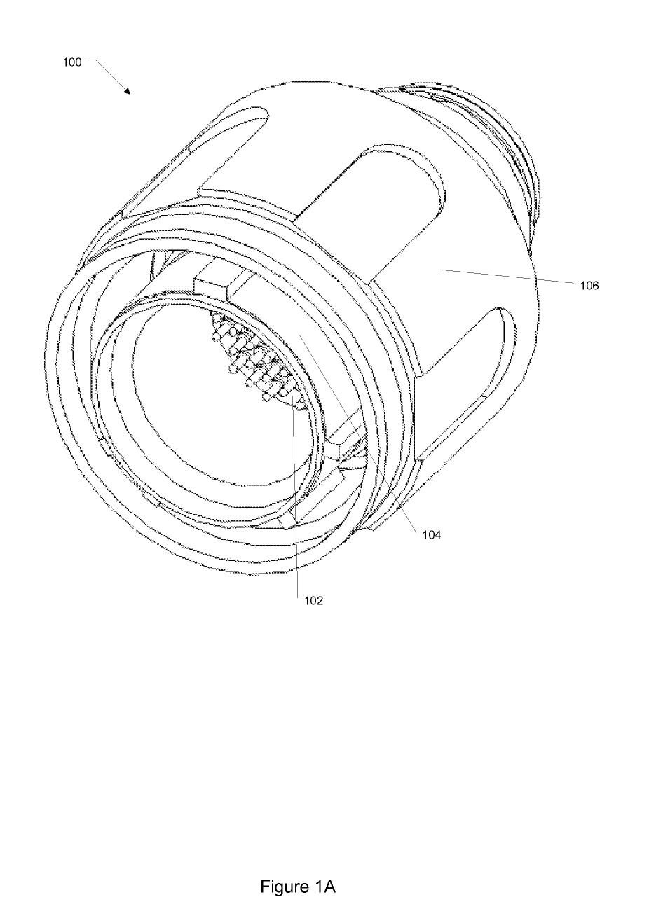

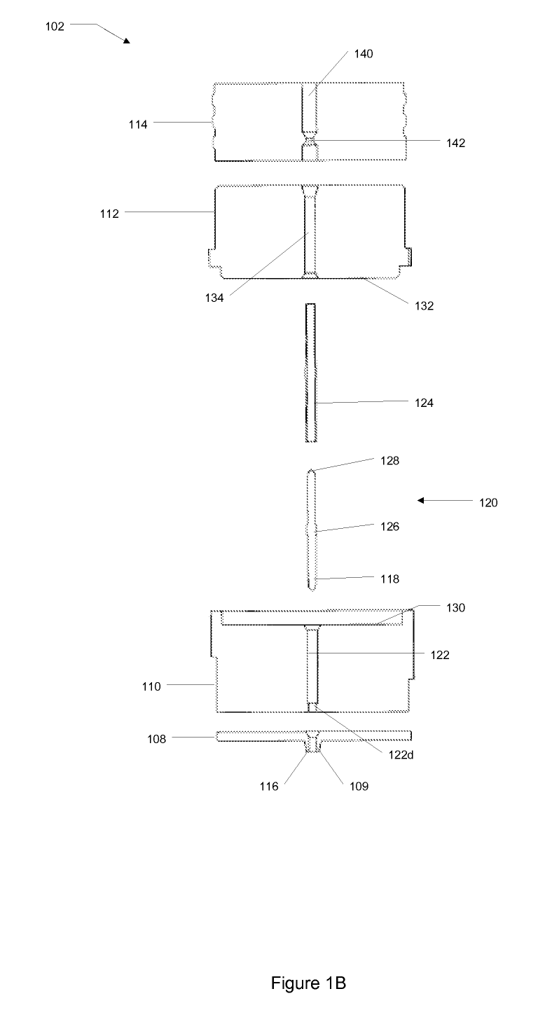

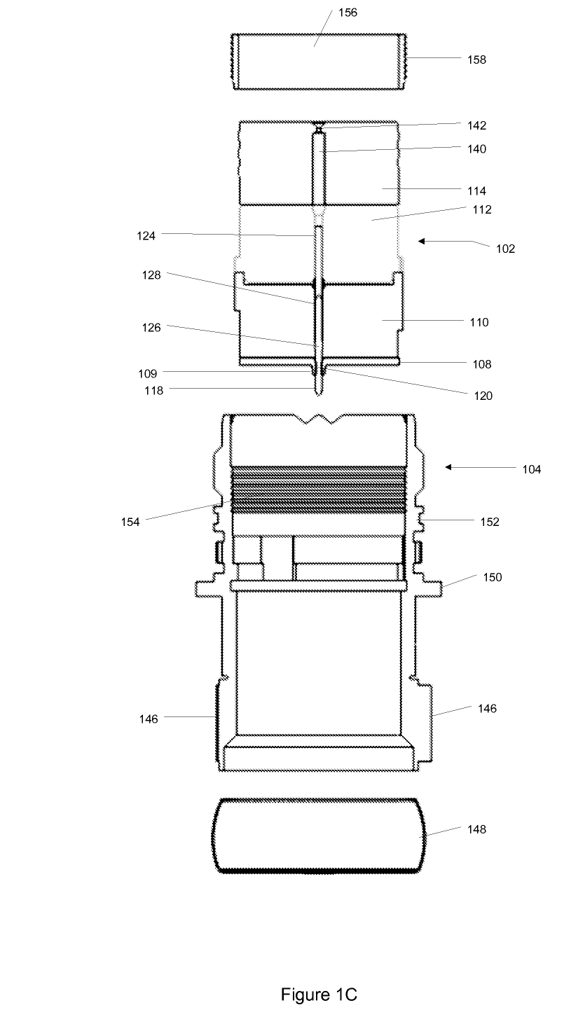

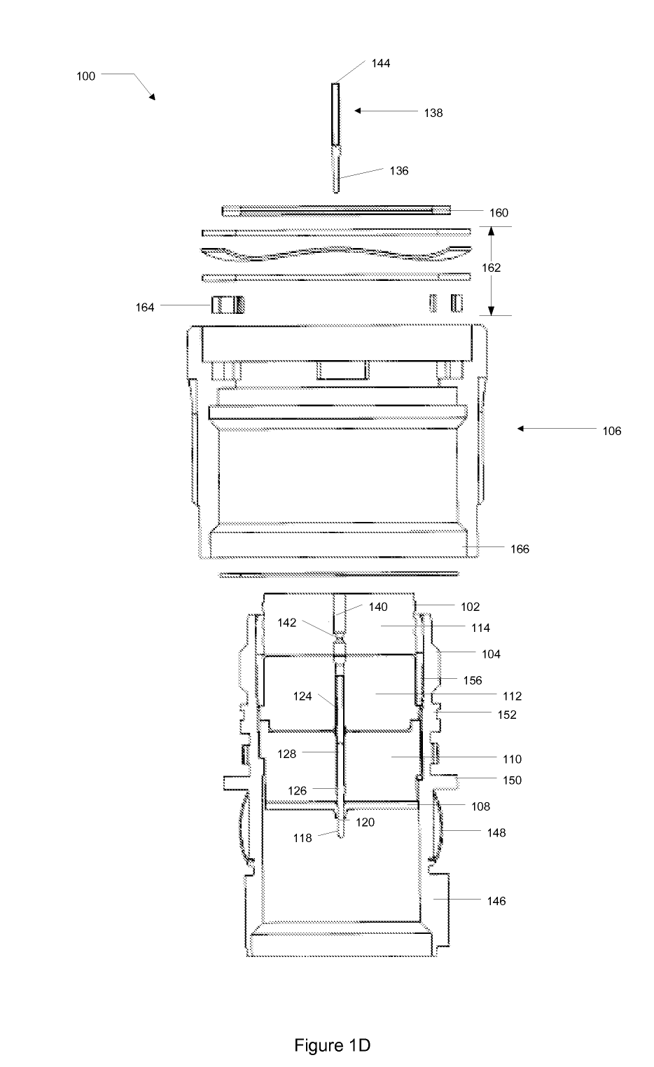

Referring to FIG. 1A, a plug 100 includes an insert assembly 102, a housing 104, and a coupling ring 106. Insert assembly 102 is disposed within housing 104. Coupling ring 106 is configured to receive housing 104, yet is capable of rotating independently of housing 104.

FIG. 1B illustrates an expanded view of the insert assembly 102 of plug 100. Insert assembly 102 is generally cylindrical. Insert assembly 102 includes an interface seal 108 coupled to a front insert 110, which is coupled to a rear insert 112, which is coupled to a seal 114. Interface seal 108, front insert 110, rear insert 112, and seal 114 may be coupled together by any means known to one having ordinary skill in the art.

Interface seal 108 includes an opening 116 through which a front end 118 of a double-ended pin 120 may be inserted and compression sealed therein. In some embodiments, interface seal 108 may include a protrusion 109 extending therefrom and surrounding double-ended pin 120 upon insertion. Interface seal 108 may be fabricated from any sealing material. Suitable sealing materials include, but are not limited to, any materials suitable for fabricating grommet seals.

Double-ended pin 120 includes a front end 118 having a generally pointed tip. However, one having ordinary skill in the art will recognize that the tip of double-ended pin 120 may be configured any number of ways as long as contact with a receptacle is possible. Double-ended pin 120 extends at least partially beyond a front end of insert assembly 102 and interface seal 108 (FIG. 1C) for insertion into a receptacle 200. In some exemplary embodiments, double-ended pin 120 may be a beryllium copper double-ended pin. In other exemplary embodiments, double-ended pin 120 may be a stainless steel double-ended pin. One having ordinary skill in the art will recognize other suitable conductive materials for fabricating double-ended pin 120.

Front insert 110 includes an opening 122 through which a portion of a conductive tube 124 is inserted. In some embodiments, conductive tube 124 may be a copper tube; however, one having ordinary skill in the art will recognize other suitable conductive materials for fabrication of conductive tube 124. A rear end 128 of double-ended pin 120 is positioned within the portion of conductive tube 124 disposed in opening 122, while a central portion 126 of double-ended pin 120 is positioned directly within opening 122. Central portion 126 of double-ended pin 120 has an outer diameter that is greater than the inner diameter of conductive tube 124, thus preventing double-ended pin 120 from entirely being pushed into conductive tube 124. Opening 122 has a diameter 122d that is smaller than the outer diameter of central portion 126 of double-ended pin 120, and prevents double-ended pin 120 from entirely being pushed out of opening 122. Because double-ended pin 120 is retained within insert assembly 102 via central portion 126, the need for the retainer required for insert assemblies having conventional contacts is eliminated. Thus insert assembly 102 may house more contacts (double-ended pins) per unit area than realized with conventional insert assemblies. Front insert 110 also may include a recess 130 designed to mate with a recess mating portion 132 of rear insert 112. Front insert 110 may be fabricated from a non-conductive material, such as a glass-filled polymer or other suitable non-conductive material. For example, in some embodiments, front insert 110 may comprise poly-phenylene sulphide (PPS).

Rear insert 112 includes an opening 134 through which a portion of conductive tube 124 is inserted. A front portion 136 of a contact pin 138 (FIG. 1D) is positioned within the portion of the conductive tube 124 within opening 134. Rear insert 112 may be fabricated from a non-conductive material. Suitable examples of non-conductive materials include, but are not limited to, glass-filled polymers such as PPS. In some embodiments, contact pin 138 may be a beryllium copper wire crimped pin contact.

Seal 114 is a grommet seal fabricated from a fluorosilicone rubber. Seal 114 includes an opening 140, wherein at least a portion 142 of opening 140 has a diameter smaller than the outer diameter of conductive tube 124. A rear portion 144 of contact pin 138 is positioned within opening 140 and sealed therein and includes an outer diameter greater than the portion 142 of opening 140, thus preventing contact pin 138 from entirely being pushed into conductive tube 124 (FIG. 1D). In some embodiments, portion 142 of opening 140 may be positioned around a wire (not shown) and also prevents contact pin 138 from being pushed out of insert assembly 102 (FIG. 1C). Generally, a user may crimp a wire (not shown) into the rear portion 144 of contact pin 138 prior to insertion into insert assembly 102.

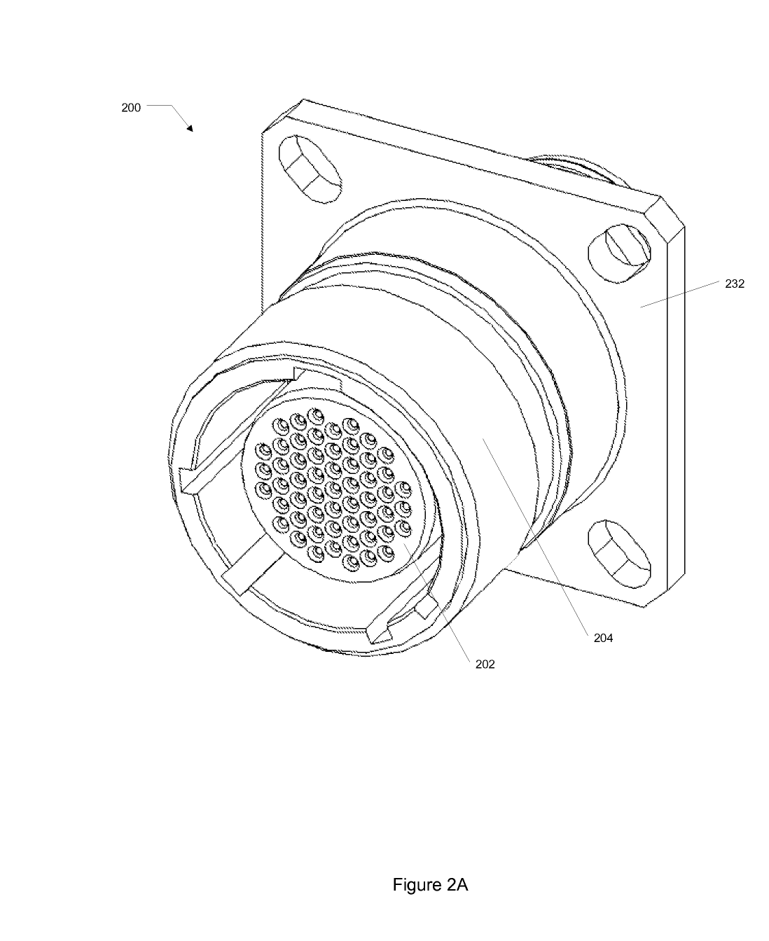

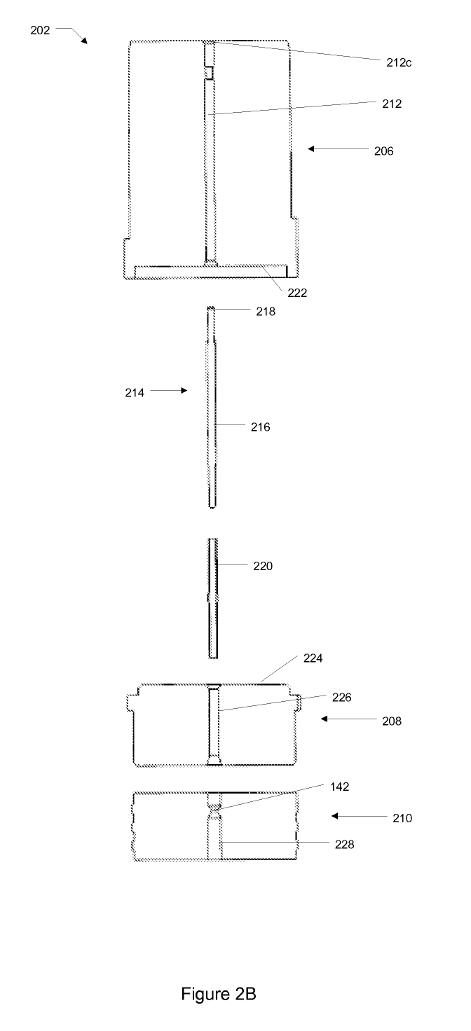

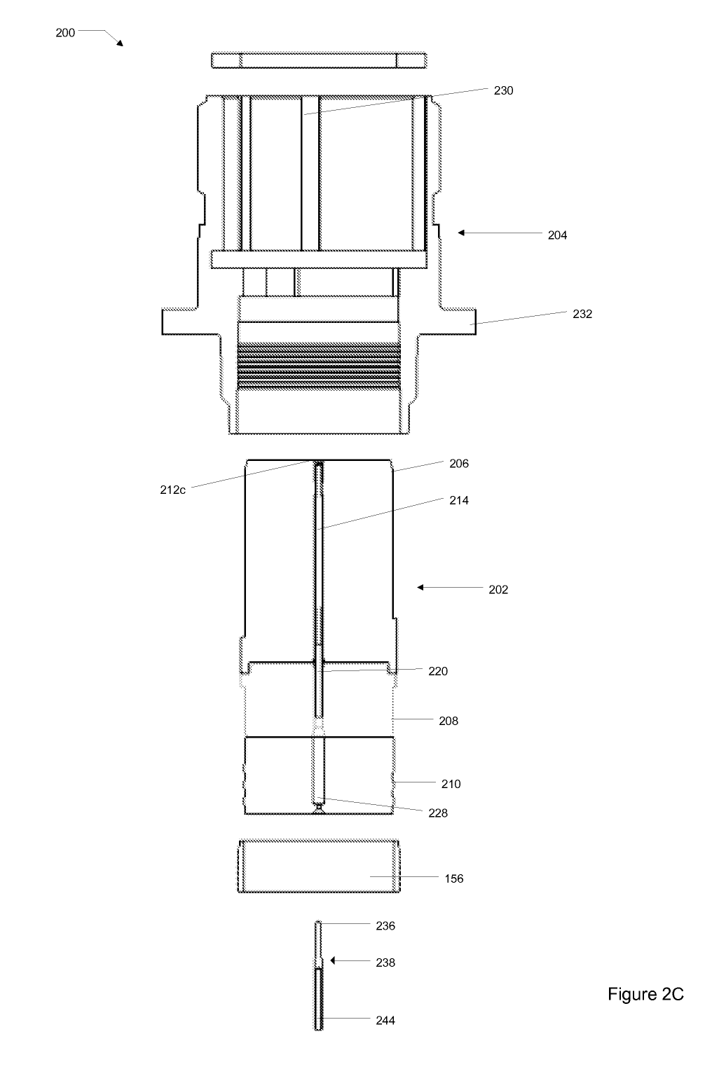

FIG. 1C refers to insert assembly 102 and housing 104 of plug 100. Housing 104 of plug 100 includes a cavity and is configured to house insert assembly 102 therewithin, as well as to be positioned at least partially within coupling ring 106 (FIG. 1D). Housing 104 includes a key 146 designed to fit and engage a key way of a mating receptacle 200 (FIG. 2A) to facilitate quick alignment and connection of the plug 100 and receptacle 200 by a user. In some embodiments, an electromagnetic interference (EMI) spring 148 may be included. When a plug 100 and mating receptacle 200 are connected, EMI spring 148 compresses and surrounds the mating connections of plug 100 and receptacle 200, thus maintaining the electrical potential around the connections to avoid discharge into air gaps around the connectors. In other words, the inclusion of EMI spring 148 results in a connection such that the plug and receptacle units become a Faraday cage.

Housing 104 also includes a ledge 150 that functions to position housing 104 within coupling ring 106 at a certain depth (which may vary from plug to plug). Additional grooves, such as groove 152, may be include on the exterior of housing 104 as needed to facilitate coupling housing 104 to the interior of coupling ring 106. Housing 104 may further include interior threads 154. To facilitate coupling insert assembly 102 to housing 104, a bonding ring 156 may be bonded to the exterior of seal 114 by any means known to one having ordinary skill in the art. Bonding ring 156 also includes exterior threads 158. Exterior threads 158 mate with interior threads 154 of housing 104 and secure insert assembly 102 within housing 104.

FIG. 1D refers to an exploded view of plug 100. Coupling ring 106 includes a cavity and is configured to receive housing 104 therewithin, yet is capable of rotating independently of housing 104. Once insert assembly 102 and housing 104 are inserted, a spiral retaining ring 160 positioned in groove 152 secures housing 104 to coupling ring 106. In some embodiments, assorted washers and springs 162, such as anti-rotational spring 164, may be included as ratchet systems. Coupling ring 106 also may include threads 166 for matingly engaging a receptacle 200 (FIG. 2A).

Referring to FIG. 2A, a receptacle 200 includes an insert assembly 202 disposed within a housing 204. Receptacle 200 is configured to mate with plug 100 as described below.

FIG. 2B refers to insert assembly 202. Insert assembly 202 is generally similar to insert assembly 102, with the difference being in the design of the front insert. Insert assembly 202 is generally cylindrical, and includes a front insert 206 coupled to a rear insert 208, which is coupled to a seal 210. Front insert 206, rear insert 208, and seal 210 may be coupled together by any means known to one having ordinary skill in the art. Rear insert 208 is similar to rear insert 112, and seal 210 is similar to seal 114. Front insert 206 includes an opening 212 into which a spring probe 214 is inserted, and spring probe 214 does not protrude outwardly from insert assembly 202. In some embodiments, as shown in the Figures, opening 212 may include a portion having angled walls, or chamfer 212c, and spring probe 214 may be recessed below the surface of front insert 206 and chamfer 212c.

Spring probe 214 includes a central portion 216 and a front end 218. Spring probe 214 includes a spring (not shown) that may be disposed within central portion 216 and positioned proximate to front end 218. Front end 218 acts as a plunger and may depress into central portion 216 upon force. Front end 218 of spring probe 214 includes a beveled tip configured to receive the tip of double-ended pin 120. The spring in spring probe 214 allows the front end 218 to retract upon force from the front end 118 of double-ended pin 120 protruding out of plug 100 when plug 100 mates with receptacle 200. In some embodiments, spring probe 214 may be a gold-plated beryllium copper double-ended pin, such as the Series S, Size 00, G Plating, 1.3 Spring Force probe commercially available from Interconnect Devices, Inc. In other embodiments, spring probe 214 may be a gold-plated double-ended pin having a stainless steel internal spring, such as the Series S, Size 00, G Plating, 1.6 Spring Force probe commercially available from Interconnect Devices, Inc.

A portion of a conductive tube 220 (similar to conductive tube 124) is partially inserted into opening 212. At least a portion of spring probe 214 is positioned within the portion of conductive tube 220 that is partially inserted into opening 212. Central portion 216 of spring probe 214 has an outer diameter that is greater than the inner diameter of conductive tube 220, thus preventing spring probe 214 from entirely being pushed into conductive tube 220. Because spring probe 214 is retained within insert assembly 202 via central portion 216, the need for the retainer required for insert assemblies having conventional contacts is eliminated. Thus, insert assembly 202 may house more contacts (spring probes) per unit area than realized with conventional insert assemblies.

Front insert 206 may include a recess 222 designed to mate with a recess mating portion 224 of rear insert 208. Front insert 206 may be fabricated from a non-conductive material, such as a glass-filled polymer. In some embodiments, front insert 206 may comprise PPS.

A front portion 236 of contact pin 238 (FIG. 2C) is positioned within the portion of the conductive tube 220 within an opening 226 of rear insert 208. A rear portion 244 of contact pin 238 is positioned within opening 228 of seal 210 and sealed therein. Generally, a user may crimp a wire (not shown) into the rear portion 244 of contact pin 238 prior to insertion into insert assembly 202.

FIG. 2C refers to an exploded view of receptacle 200 showing insert assembly 202, housing 204, contact pin 238, and bonding ring 156. Housing 204 of receptacle 200 is configured to house insert assembly 202 within. A bonding ring 156 may be used to secure insert assembly 202 within housing 204 similar to the way insert assembly 102 is secured to housing 104. Housing 204 includes a key way 230 designed to receive and matingly engage key 146 of plug 100 and to secure the plug 100 and receptacle 200 together. Housing 204 may further include a mounting surface 232 for mounting receptacle 200 to a surface or box (not shown).

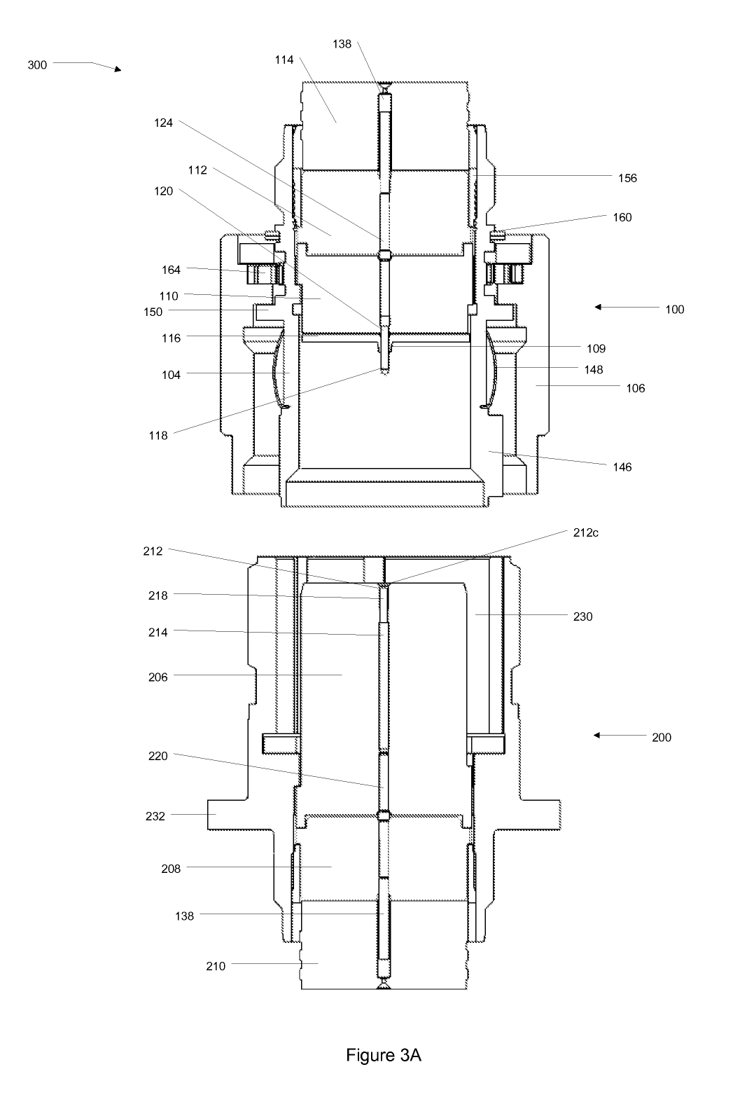

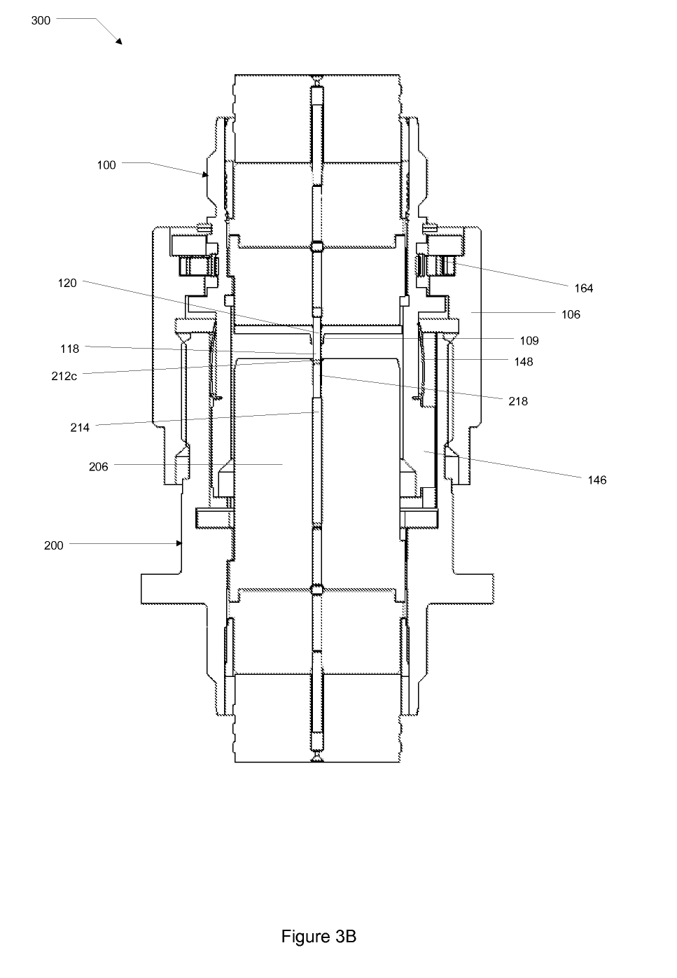

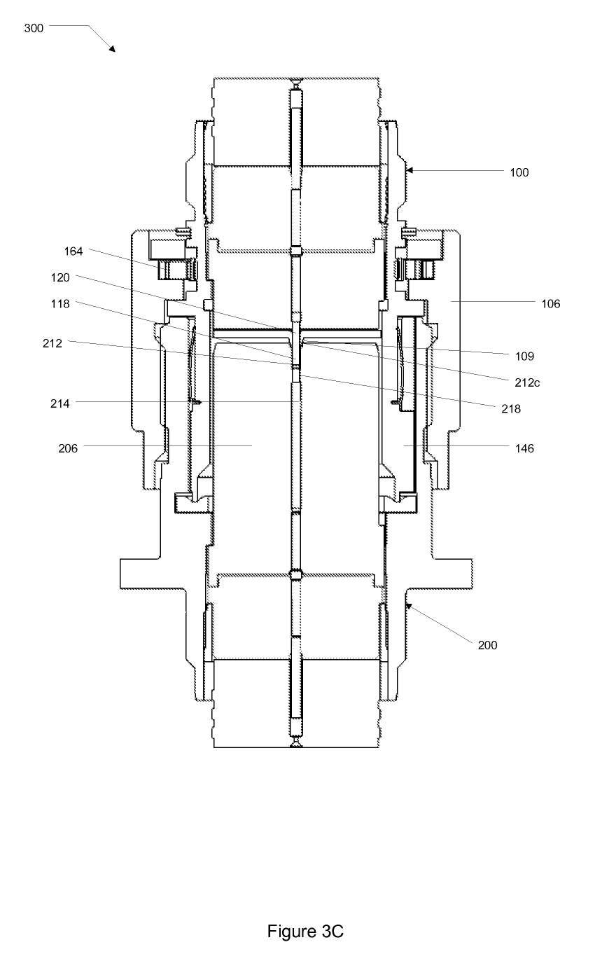

Referring to FIGS. 3A-3C, a connector 300 of the present invention includes a plug 100 and a receptacle 200. FIG. 3A refers to plug 100 and receptacle 200 disconnected. FIG. 3B refers to plug 100 partially connected to receptacle 200, whereby front end 118 of double-ended pin 120 enters opening 212 of front insert 206 of receptacle 200. At this stage, front end 118 of double-ended pin 120 may or may not be in contact with front end 218 of spring probe 214, and therefore conductive contact may not be achieved. Referring to FIG. 3C, when plug 100 completely mates with receptacle 200, protrusion 109 of interface seal 108 enters the chamfer 212c of front insert 206 and spring action allows compression of spring probe 214 to achieve definite conductive contact and an environmental seal between plug 100 and receptacle 200, and coupling ring 106 rotates independently and locks the plug 100 and receptacle 200 in place. Coupling ring 106 and anti-rotational spring 164 may aid in preventing coupling ring 106 from accidentally unlocking or unthreading after plug 100 and receptacle 200 are engaged. Thus, an improved connector is realized achieving similar environmental performance levels of conventional connectors, while having an increased contact number per unit area. For example, an insert assembly with shell size 13 has a diameter of about 0.522 inches and can include 55 contacts according to an exemplary embodiment of the invention, while an insert assembly with shell size 17 has a diameter of about 0.772 inches and can include 139 contacts. Additionally, the inclusion of the spring probe 214 eliminates the insertion forces that were present in conventional connectors.

Therefore, the present invention is well adapted to attain the ends and advantages mentioned as well as those that are inherent therein. The particular embodiments disclosed above are illustrative only, as the present invention may be modified and practiced in different but equivalent manners apparent to those having ordinary skill in the art having the benefit of the teachings herein. Having described some exemplary embodiments of the present invention, it is believed that the use of alternate housing configurations and coupling rings is within the purview of those having ordinary skill in the art. Additionally, while the present application generally illustrates cylindrical insert assemblies, housings, and coupling rings, it is understood that a number of other non-circular configurations may be used. Furthermore, FIGS. 1B-1D, 2B-2C, and 3A-3C illustrate connector units having a single double-ended pin and/or spring probe for convenience. However, it is understood that multiple double-ended pins and/or spring probes may be included within the insert assemblies by duplicating the items in a desired pattern, as limited by the cross-sectional area of the insert assemblies.

Additionally, certain alternative exemplary embodiments are within the scope of the present invention. For example, the spring probe in the receptacle may extend beyond the corresponding front insert, and the double-ended pin in the plug may be recessed within the corresponding front insert by modifying the design of the front inserts accordingly. Furthermore, the spring probe can be used in the plug instead of the receptacle, and the double-ended pin can be used in the receptacle instead of the pin.

While numerous changes may be made by those having ordinary skill in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. The terms in the claims have their plain, ordinary meaning unless otherwise explicitly and clearly defined by the patentee.

What is claimed is:

1. A plug, comprising:
a housing; and
an insert assembly disposed in the housing and comprising (1) an interface seal comprising a plurality of openings and a corresponding plurality of protrusions that each extend from a circumference of a respective one of the openings and (2) a plurality of double-ended pins each protruding at least partially from a respective one of the openings and protrusions.

2. The plug of claim 1, wherein the plug further comprises a coupling ring, and wherein the housing is positioned within the coupling ring.

3. The plug of claim 1, wherein the insert assembly further comprises a front insert coupled to the interface seal, the front insert having a plurality of front insert openings in which corresponding ones of the plurality of double-ended pins are at least partially disposed.

4. The plug of claim 3, wherein at least a portion of each of the plurality of front insert openings have a diameter that is less than a diameter of a central portion of each of the plurality of double-ended pins.

5. The plug of claim 3, wherein the insert assembly further comprises a rear insert coupled to the front insert, the rear insert comprising a plurality of rear insert openings and a plurality of corresponding conductors each positioned at least partially within a respective one of the rear insert openings, the plurality of conductors contacting the plurality of double-ended pins.

6. The plug of claim 5, wherein the insert assembly further comprises a rear seal coupled to the rear insert, the rear seal comprising a plurality of rear seal openings and a plurality of corresponding contacts each being at least partially positioned within a respective one of the rear seal openings, the plurality of contacts contacting the plurality of conductors.

7. The plug of claim 6, wherein at least a portion of each of the plurality of rear seal openings have a diameter that is less than a diameter of the conductors.

8. The plug of claim 6, wherein the plurality of conductors comprises a plurality of conductive tubes each disposed within a respective one of the front insert openings and a respective one of the rear insert openings, wherein each of the double-ended pins is at least partially disposed within a portion of a respective one of the conductive tubes and wherein each of the contacts is disposed within another portion of a respective one of the conductive tubes.

9. A connector, comprising:
a plug comprising a plug housing and a double-ended pin protruding at least partially therefrom; and
a receptacle comprising a receptacle housing and a spring probe at least partially recessed therein,
wherein the double-ended pin of the plug contacts the spring probe of the receptacle when the plug and the receptacle are inserted together.

10. The connector of claim 9, wherein the plug further comprises a first assembly disposed in the plug housing and comprising a first front insert having an opening in which the double-ended pin is at least partially disposed.

11. The connector of claim 10, wherein at least a portion of the first front insert opening has a diameter that is less than a diameter of a central portion of the double-ended pin.

12. The connector of claim 10, wherein the first assembly further comprises an interface seal coupled to the first front insert, the interface seal having an opening through which the double-ended pin protrudes at least partially therefrom.

13. The connector of claim 12, wherein the interface seal comprises a protrusion extending from the interface seal opening and surrounding at least a portion of the double-ended pin that is protruding from the interface seal opening.

14. The connector of claim 10, wherein the first assembly further comprises a first rear insert coupled to the first front insert, the first rear insert comprising an opening and a first conductor positioned at least partially within the opening, the first conductor contacting the double-ended pin.

15. The connector of claim 14, wherein the first assembly further comprises a rear seal coupled to the first rear insert, the rear seal comprising an opening and a first contact at least partially positioned within the opening, the first contact contacting the first conductor.

16. The connector of claim 15, wherein at least a portion of the rear seal opening has a diameter that is less than a diameter of the first conductor.

17. The connector of claim 15, wherein the first conductor comprises a conductive tube disposed within the first front insert opening and the first rear insert opening, wherein the double-ended pin is at least partially disposed within a portion of the first conductive tube and the first contact is at least partially disposed within another portion of the first conductive tube.

18. The connector of claim 9, wherein the receptacle comprises a second assembly disposed in the receptacle housing and comprising a second front insert having an opening in which the spring probe is recessed.

19. The connector of claim 18, wherein the second front insert opening comprises at least one tapered wall.

20. The connector of claim 18, wherein the second assembly further comprises a second rear insert coupled to the second front insert, the second rear insert comprising an opening and a second conductor positioned at least partially within the opening, the conductor contacting the spring probe.

21. The connector of claim 20, wherein the second insert assembly further comprises a second seal coupled to the second rear insert, the second seal comprising an opening and a second contact at least partially positioned within the opening, the second contact contacting the second conductor.

22. The connector of claim 21, wherein at least a portion of the second seal opening has a diameter that is less than a diameter of the second conductor.

23. The connector of claim 21, wherein the second conductor comprises a conductive tube disposed within the second front insert opening and the second rear insert opening, wherein the spring probe is at least partially disposed within a portion of the second conductive tube and the second contact is disposed within another portion of the second conductive tube.

24. The connector of claim 9, wherein the plug further comprises a first assembly disposed in the plug housing and comprising an interface seal having an opening through which the double-ended pin protrudes at least partially therefrom, wherein the interface seal comprises a protrusion extending from the interface seal opening and surrounding at least a portion of the double-ended pin that is protruding from the interface seal opening,
wherein the receptacle further comprises a second assembly disposed in the receptacle housing and comprising a second front insert having an opening in which the spring probe is recessed, and
wherein the protrusion is disposed in the second front insert opening when the plug and receptacle are connected.

25. An insert assembly for a connector, comprising:
an interface seal comprising a plurality of openings and a corresponding plurality of protrusions that each extend from a circumference of a respective one of the openings; and
a plurality of double-ended pins each protruding at least partially from a respective one of the openings and protrusions.

26. The insert assembly of claim 25, further comprising a front insert coupled to the interface seal, the front insert having a plurality of front insert openings in which corresponding ones of the plurality of double-ended pins are at least partially disposed, wherein at least a portion of each of the plurality of front insert openings have a diameter that is less than a diameter of a central portion of each of the plurality of double-ended pins.

27. The insert assembly of claim 26, further comprising a rear insert coupled to the front insert, the rear insert comprising a plurality of rear insert openings and a plurality of corresponding conductors each positioned at least partially within a respective one of the rear insert openings, the plurality of conductors contacting the plurality of double-ended pins.

28. The insert assembly of claim 27, further comprising a rear seal coupled to the rear insert, the rear seal comprising a plurality of rear seal openings and a plurality of corresponding contacts each being at least partially positioned within a respective one of the rear seal openings, the plurality of contacts contacting the plurality of conductors, wherein at least a portion of each of the plurality of rear seal openings have a diameter that is less than a diameter of the conductors, wherein the plurality of conductors comprises a plurality of conductive tubes each disposed within a respective one of the front insert openings and a respective one of the rear insert openings, wherein each of the double-ended pins is at least partially disposed within a portion of a respective one of the conductive tubes and wherein each of the contacts is disposed within another portion of a respective one of the conductive tubes.

29. A receptacle, comprising:
a housing; and
an insert assembly positioned within the housing and comprising
a rear insert comprising a plurality of rear insert openings and a plurality of conductors each positioned at least partially within a respective one of the rear insert openings, and
a plurality of spring probes at least partially recessed within the insert assembly and contacting the plurality of conductors.

30. The receptacle of claim 29, wherein the insert assembly further comprises a front insert comprising a plurality of front insert openings, each of the spring probes being recessed within a corresponding one of the front insert openings.

31. The receptacle of claim 30, wherein each of the front insert openings comprises at least one angled wall.

32. The receptacle of claim 29, wherein the insert assembly further comprises a rear seal coupled to the rear insert, the rear seal comprising a plurality of rear seal openings and a plurality of contacts each being at least partially positioned within a corresponding one of the rear seal openings, the plurality of contacts contacting the plurality of conductors.

33. The receptacle of claim 32, wherein at least a portion of each of the plurality of rear seal openings have a diameter that is less than a diameter of each of the plurality of conductors.

34. The receptacle of claim 32, wherein the plurality of conductors comprises a plurality of conductive tubes that are each disposed within the a respective one of the front insert openings and a respective one of the rear insert openings, wherein each of the spring probes is at least partially disposed within a portion of a respective one of the conductive tubes and wherein each of the contacts is disposed within another portion of a respective one of the conductive tubes.

35. A connector, comprising:
a receptacle comprising a receptacle housing and a spring probe at least partially recessed therein; and
a plug configured to mate with the receptacle.

36. The connector of claim 35, wherein the plug comprises a plug housing and a double-ended pin protruding at least partially therefrom, and wherein the double-ended pin contacts the spring probe of the receptacle when the plug and the receptacle are inserted together.

37. The connector of claim 35, wherein the receptacle comprises an assembly disposed in the receptacle housing and comprising a front insert having an opening in which the spring probe is recessed.

38. The connector of claim 37, wherein the front insert opening comprises at least one tapered wall.

39. The connector of claim 37, wherein the assembly further comprises a rear insert coupled to the front insert, the rear insert comprising an opening and a conductor positioned at least partially within the opening, the conductor contacting the spring probe.

40. The connector of claim 39, wherein the insert assembly further comprises a seal coupled to the rear insert, the seal comprising an opening and a contact at least partially positioned within the opening, the contact contacting the conductor.

41. The connector of claim 40, wherein at least a portion of the seal opening has a diameter that is less than a diameter of the conductor.

42. The connector of claim 40, wherein the conductor comprises a conductive tube disposed within the front insert opening and the rear insert opening, wherein the spring probe is at least partially disposed within a portion of the conductive tube and the contact is disposed within another portion of the conductive tube.

43. An insert assembly for a connector, comprising:
a rear insert comprising a plurality of rear insert openings and a plurality of conductors each positioned at least partially within a respective one of the rear insert openings; and
a plurality of spring probes at least partially recessed within the insert assembly and contacting the plurality of conductors.

44. The insert assembly of claim 43, further comprising a front insert comprising a plurality of front insert openings, each of the spring probes being recessed within a corresponding one of the front insert openings.

45. The insert assembly of claim 44, wherein each of the front insert openings comprises at least one angled wall.

46. The insert assembly of claim 43, wherein the insert assembly further comprising a rear seal coupled to the rear insert, the rear seal comprising a plurality of rear seal openings and a plurality of contacts each being at least partially positioned within a corresponding one of the rear seal openings, the plurality of contacts contacting the plurality of conductors.

47. The insert assembly of claim 46, wherein at least a portion of each of the plurality of rear seal openings have a diameter that is less than a diameter of each of the plurality of conductors.

48. The insert assembly of claim 46, wherein the plurality of conductors comprises a plurality of conductive tubes that are each disposed within the a respective one of the front insert openings and a respective one of the rear insert openings, wherein each of the spring probes is at least partially disposed within a portion of a respective one of the conductive tubes and wherein each of the contacts is disposed within another portion of a respective one of the conductive tubes.
